(19) United States
(12) Patent Application Publication
(10) Pub. No.: US 2004/0111986 A1
(43) Pub. Date: Jun. 17, 2004

(54) Bullet resistant glass panel

(76) Inventor: Armand Zurhaar, Western Australia (AU)

Correspondence Address: BACHMAN & LAPOINTE, P.C., 900 CHAPEL STREET, SUITE 1201, NEW HAVEN, CT, 06510, US

(21) Appl. No.: 10/468,966

(22) PCT Filed: Feb. 26, 2002
(86) PCT No.: PCT/AU02/00194

(30) Foreign Application Priority Data
Jul. 9, 2001 (AT) GM 542/2001

(51) Int. Cl. E06B 3/26; E04C 2/00

(52) U.S. Cl. 52/202; 52/796.1

(57) ABSTRACT

A bullet resistant glass panel comprising a plurality or parallel glass sheets arranged adjacent to each other. Each glass sheet includes at least one layer of a transparent polymeric film on a first side and at least one layer of a transparent polymeric film on a second side of the glass sheet. The total thickness of the or each layer of transparent polymeric film on the second side is greater than the total thickness of the or each layer of transparent polymeric film on the first side. The first sides are arranged to face a direction from which the impact of a bullet is expected. The thickness of the or each further glass sheet is less than or equal to the thickness of a preceding glass sheet.

### FIELD OF THE INVENTION

The present invention relates to a bullet resistant glass panel.

### BACKGROUND OF THE INVENTION

Bullet resistant glass panels are used in a wide range of locations where additional security is required. However, the cost of such panels is generally high and may preclude the use of bullet resistant glass panels in applications which may otherwise benefit from their use.

Bullet resistant glass panels are generally constructed from parallel layers of glass and plastics materials. For example, it is common to construct a panel from a sheet of polycarbonate sandwiched between two layers of glass. The panels are rated according to the type of weapon fire that they can withstand and to increase the security rating of a panel, the thickness of the panel is generally increased. The increase in thickness not only increases costs but increases the difficulties encountered during installation resulting from a consequent increase in size and weight of the panels.

The present invention attempts to overcome, at least in part, the aforementioned disadvantages of previous bullet resistant glass panels by providing a bullet resistant glass panel which is relatively thin compared to known conventional panels while offering similar protection.

### SUMMARY OF THE INVENTION

In accordance with a first aspect of the present invention there is provided a bullet resistant glass panel comprising a plurality of parallel glass sheets disposed adjacent to each other, wherein each glass sheet includes at least one layer of a transparent polymeric film on a first side thereof and at least one layer of a transparent polymeric film on the second side being greater than the total thickness of the or each layer of transparent polymeric film on the first side, the first sides of the glass sheets being arranged to substantially face a direction from which the impact of a bullet is expected.

In accordance with a second aspect of the present invention there is provided a bullet resistant glass panel comprising a first glass sheet having a first side, the first side being arranged to substantially face a direction from which the impact of a bullet is expected, and a second side opposed to the first side, and a further glass sheet located parallel and adjacent to the second side of the first glass sheet, and, optionally, one or more yet further glass sheets having first sides located parallel and adjacent to the second sides of preceding glass sheets, wherein the thickness of the or each further glass sheet is less than or equal to the thickness of a preceding glass sheet and the thickness of at least one of the further glass sheets is less than the thickness of the first glass sheet.

### DESCRIPTION OF THE DRAWINGS

The present invention will now be described, by way of example, with reference to the accompanying drawings, in which:

FIG. 1 is a side exploded view of a bullet resistant glass panel in accordance with a first aspect of the present invention; and

FIG. 2 is a side exploded view of a bullet resistant glass panel in accordance with a second aspect of the present invention.

### DETAILED DESCRIPTION OF THE INVENTION

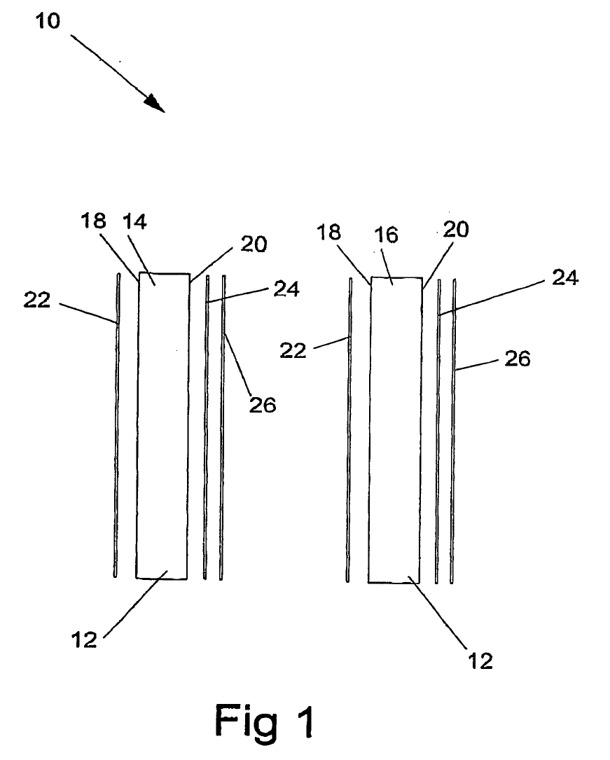

Referring to the FIG. 1, there is shown a bullet resistant glass panel 10 comprising a plurality of glass sheets 12. Each glass sheet 12 includes a transparent polymeric film applied to first and second sides thereof where the thickness of transparent polymeric film on the second side is greater than the thickness of transparent polymeric film on the first side, and the first side 18 is arranged in use to substantially face a direction from which impact by a bullet is expected.

In the embodiment shown in FIG. 1, there is provided a first glass sheet 14 and a second glass sheet 16. Each of the first and second glass sheets 14 and 16 includes a first side 18 and a second side 20. A first layer of a transparent polymeric film 22 is applied to the first side 18 of each of the first and second glass sheets 14 and 16. A second layer of transparent polymeric film 24 is applied to the second side 20 of each of the first and second glass sheets 14 and 16. A third layer of transparent polymeric film 26 is applied to the second layer of transparent polymeric film 24. It should be noted that although FIG. 1 shows an exploded view of each of the first and second glass sheets 14 and 16 and the transparent polymeric films 22, 24 and 26, in use the transparent polymeric films 22, 24 and 26 are disposed contiguously on the surface of the glass sheets 14 and 16.

In use, the first and second glass sheets 14 and 16 are arranged within a frame to form the bullet resistant glass panel 10 such that the first transparent polymeric film 22 of the second glass sheet 16 comes into contact with the third film 26 of the first glass sheet 14. If a bullet resistant glass panel 10 is required of additional strength, then further glass sheets may be added in the same manner and with the same configuration of transparent polymeric films.

The transparent polymeric film is preferably a polyester film, for example, polyethylene terephthalate (PET) preferably having a thickness of between 375 to 400 micron, although the thickness of each film may be substantially less than 375 micron. Typically, a cumulative thickness of a plurality of layers of transparent polyester film is from about 100 microns to about 1000 microns. Further, the transparent polyester film may also be formed from MYLAR®), polyacrylics, perspex, polycarbonates, polyacetyls, teflons, or polythenes.

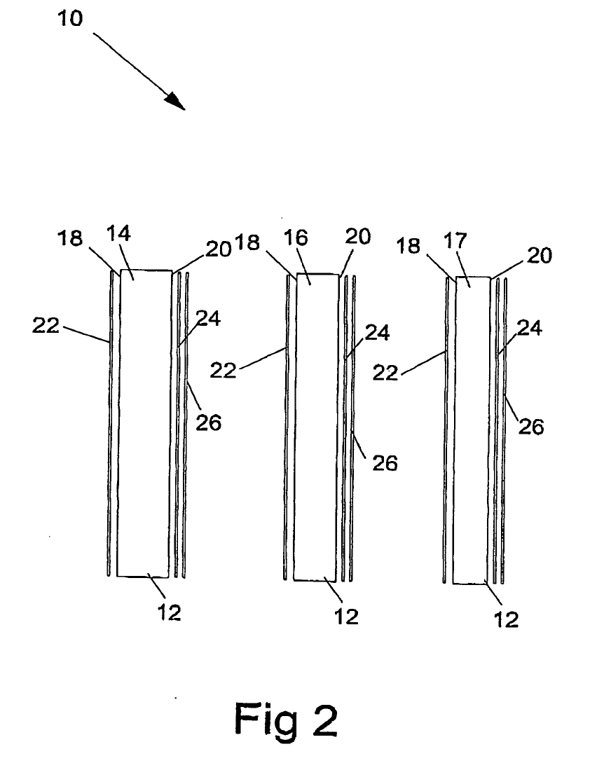

Referring to FIG. 2 there is shown a bullet resistant glass panel 10 in accordance with a second aspect of the present invention. The bullet resistant glass panel 10 comprises a first glass sheet 14 and at least one further glass sheet. Each of the further glass sheets has a thickness less than or equal to that of the previous glass sheet.

In the embodiment shown in FIG. 2, there is provided a first glass sheet 14, a second glass sheet 16 and a third glass sheet 17. Each of the glass sheets, 14, 16 and 17 is provided with first, second and third transparent polymeric films 22, 24 and 26 arranged as described above in relation to FIG. 1.

The second glass sheet 16 is constructed of a thickness of glass less than that of the first glass sheet 14. The third glass sheet 17 is constructed of a thickness of glass less than that of the second glass sheet 16. For example the thickness of the first glass sheet 14 may be 10 mm, the thickness of the second glass sheet 16 may be 8 mm and the thickness of the third glass sheet 17 may be 6 mm.

In use, the first, second and third glass sheets 14, 16 and 17 are arranged within a frame to form the bullet resistant glass panel 10 such that the first transparent polymeric film 22 of the second glass sheet 16 comes into contact with the third transparent polymeric film 26 of the first glass sheet 14 and the first transparent polymeric film 22 of the third glass sheet 17 comes into contact with the third transparent polymeric film 26 of the second glass sheet 16. If a bullet resistant glass panel 10 is required of additional strength, then further glass sheets may be added in the same manner with the same configuration of transparent polymeric films.

Modifications and variations as would be apparent to a skilled addressee are deemed to be within the scope of the present invention.

1. Bullet resistant glass panel comprising a plurality of parallel glass sheets arranged adjacent each other, wherein each glass sheet includes at least one layer of a transparent polymeric film on a first side thereof and at least one layer of a transparent polymeric film on a second side thereof, the total thickness of the or each layer of transparent polymeric film on the second side being greater than the total thickness of the or each layer of transparent polymeric film on the first side and the first sides of the glass sheets being arranged to face a direction from which the impact of a bullet is expected.

2. Bullet resistant glass panel according to claim 1, wherein each glass sheet is disposed contiguously with an adjacent glass sheet.

3. Bullet resistant glass panel according to claim 1 or claim 2, wherein the transparent polymeric film is formed from polyethylene terephthalate.

4. Bullet resistant glass panel according to any one of claims 1 to 3, wherein the thickness of the transparent polymeric film is between 375 to 400 micron.

5. Bullet resistant glass panel comprising a first glass sheet having a first side being arranged to face a direction from which the impact of a bullet is expected and a second side opposed to the first side, and a further glass sheet located parallel and adjacent to the second side of the first glass sheet, and, optionally, one or more yet further glass sheets having first sides located parallel and adjacent to the second sides of preceding glass sheets, wherein the thickness of the or each further glass sheet is less than or equal to the thickness of a preceding glass sheet and the thickness of at least one of the further glass sheets is less than the thickness of the first glass sheet.

6. Bullet resistant glass panel according to claim 5, wherein each glass sheet includes at least one layer of a transparent polymeric film on a first side thereof and at least one layer of a transparent polymeric film on a second side thereof, the total thickness of the or each layer of transparent polymeric film on the second side being greater than the total thickness of the or each layer of transparent polymeric film on the first side and the first sides of the glass sheets being arranged to face a side from which the impact of a bullet is expected.

7. Bullet resistant glass panel according to claim 5 or claim 6, wherein each glass sheet is disposed contiguously with an adjacent glass sheet.

8. Bullet resistant glass panel according to any one of claims 5 to 7, wherein the transparent polymeric film is formed from polyethylene terephthalate.

9. Bullet resistant glass panel according to any one of claims 5 to 8, wherein the thickness of the transparent polymeric film is between 375 to 400 micron.
